(19) United States
(12) Patent Application Publication
(10) Pub. No.: US 2019/0099778 A1
(43) Pub. Date: Apr. 4, 2019

(54) IMPROVED PAINT ROLLER

(71) Applicant: Francisco Antoniazzi, Duluth, GA (US)

(72) Inventor: Francisco Antoniazzi, Duluth, GA (US)

(21) Appl. No.: 15/723,328

(22) Filed: Oct. 3, 2017

(51) Int. Cl. B05C 17/02

(52) U.S. Cl. CPC B05C 17/0212

(57) ABSTRACT

The improved paint roller is configured for use in applying paint. The improved paint roller is configured for use in applying paint to a non-Euclidean application surface wherein the non-Euclidean application surface is selected from the group consisting of a concave surface or a convex surface. The improved paint roller comprises a roller sleeve and a handle. The roller sleeve presents a non-Euclidean face selected from the group consisting of a concave face or a convex face. The roller sleeve is configured for use in applying the paint to the non-Euclidean application surface. Specifically: 1) a roller sleeve presenting a concave face is intended to apply paint upon a convex non-Euclidean application surface; while, 2) the roller sleeve presenting a convex face is intended to apply paint upon a concave non-Euclidean application surface.

### CROSS REFERENCES TO RELATED APPLICATIONS

Not Applicable

### STATEMENT REGARDING FEDERALLY SPONSORED RESEARCH

Not Applicable

### REFERENCE TO APPENDIX

Not Applicable

### BACKGROUND OF THE INVENTION

The present invention relates to the field of performing operations including separating and mixing, more specifically, a rolling hand tool for applying a liquid to a surface.

The traditional paint roller is a cylindrical rolling device that is used to apply paint on a flat surface. The traditional paint roller comprises a roller sleeve 101 and a handle 102. The roller sleeve 101 traditionally comprises a hollow cylindrical core and a napped covering 112. The napped covering 112 covers the exterior of the hollow cylindrical core. The napped covering 112 is used to absorb paint, or some other liquid, in preparation for applying the liquid to a Euclidean surface by rolling the hollow cylindrical core over the plane surface. The handle 102 traditionally comprises a grip 123, a spring frame 122, and a spring cage 121. The spring cage 121 is a cage the bars of which enclose an openwork surface that is inserted into the roller sleeve 101. The bars of the spring cage 121 is formed from an elastomeric material. When the spring cage 121 is inserted into the hollow cylindrical core, the bars of the spring cage 121 are deflected. The forces exerted by the spring cage 121 as the spring cage 121 returns to its relaxed shape press against the interior surface of the hollow cylindrical core thereby securing the hollow cylindrical core to the spring cage 121. The spring cage 121 is mounted to the spring frame 122 with a bearing. The bearing allows the spring cage 121 to rotate relative to the spring frame 122. The spring frame 122 attaches the spring cage 121 to the grip 123. The grip 123 acts as a handhold for the traditional paint roller.

While traditional paint rollers can be efficient in the application of paint in a Euclidean plane, traditional paint rollers are not suitable for many curved, or non-Euclidean, application surfaces 141 because of the small proportion of the exterior surface area of the hollow cylindrical core that can actually put in contact with the non-Euclidean application surface 141.

Clearly, a paint roller that can apply paint to a non-Euclidean application surface 141 such as a column, cylindrical post, pipe, or pole would be of benefit in painting.

### SUMMARY OF INVENTION

The above shortcomings of a paint roller are addressed in this disclosure.

The improved paint roller is configured for use in applying paint. The improved paint roller is configured for use in applying paint to a non-Euclidean application surface wherein the non-Euclidean application surface is selected from the group consisting of a concave surface or a convex surface. The improved paint roller comprises a roller sleeve and a handle. The roller sleeve presents a non-Euclidean face selected from the group consisting of a concave face or a convex face. The roller sleeve is configured for use in applying the paint to the non-Euclidean application surface. Specifically: 1) a roller sleeve presenting a concave face is intended to apply paint upon a convex non-Euclidean application surface; while, 2) the roller sleeve presenting a convex face is intended to apply paint upon a concave non-Euclidean application surface.

These together with additional objects, features and advantages of the improved paint roller will be readily apparent to those of ordinary skill in the art upon reading the following detailed description of the presently preferred, but nonetheless illustrative, embodiments when taken in conjunction with the accompanying drawings.

In this respect, before explaining the current embodiments of the improved paint roller in detail, it is to be understood that the improved paint roller is not limited in its applications to the details of construction and arrangements of the components set forth in the following description or illustration. Those skilled in the art will appreciate that the concept of this disclosure may be readily utilized as a basis for the design of other structures, methods, and systems for carrying out the several purposes of the improved paint roller.

It is therefore important that the claims be regarded as including such equivalent construction insofar as they do not depart from the spirit and scope of the improved paint roller. It is also to be understood that the phraseology and terminology employed herein are for purposes of description and should not be regarded as limiting.

### BRIEF DESCRIPTION OF DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the appended claims.

FIG. 1 is a perspective view of an embodiment of the disclosure.

FIG. 2 is a top exploded view of an embodiment of the disclosure.

FIG. 3 is a front view of an embodiment of the disclosure.

FIG. 4 is a side view of an embodiment of the disclosure.

FIG. 5 is an in use view of an embodiment of the disclosure.

FIG. 6 is a front view of an alternate embodiment of the disclosure.

FIG. 7 is a detail view of an embodiment of the disclosure.

FIG. 8 is a perspective view of an alternate embodiment of the disclosure.

FIG. 9 is a front view of an alternate embodiment of the disclosure.

FIG. 10 is an in use view of an alternate embodiment of the disclosure.

FIG. 11 is a detail view of an alternate embodiment of the disclosure.

### DETAILED DESCRIPTION OF THE EMBODIMENT

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description.

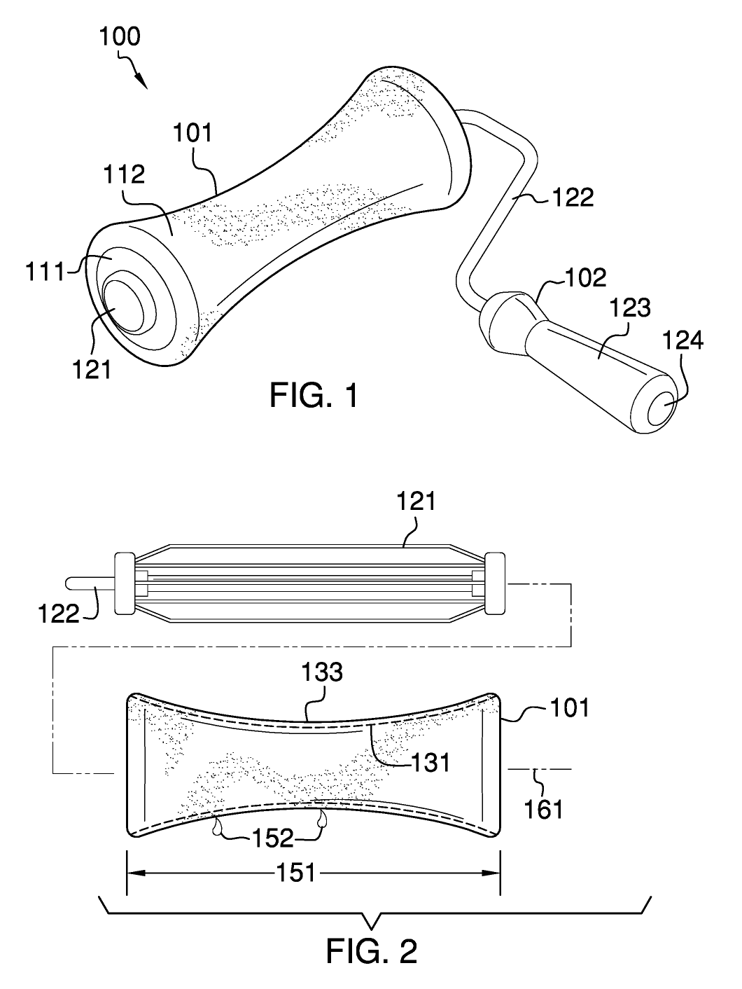

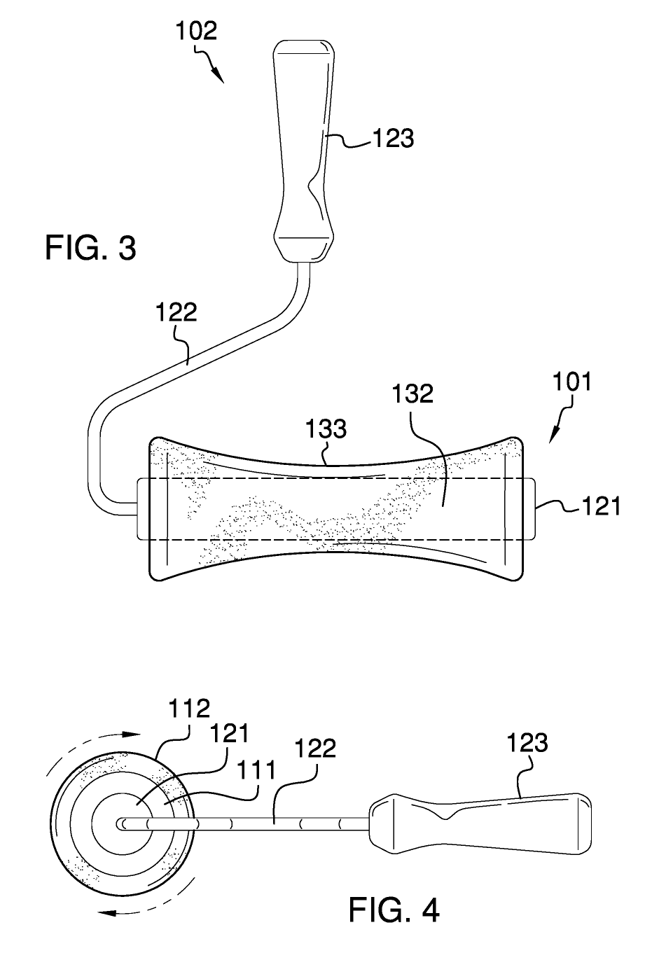

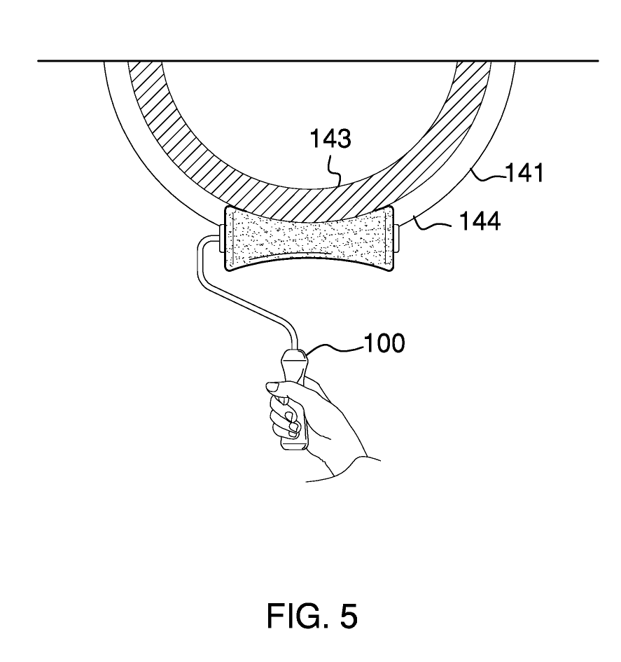

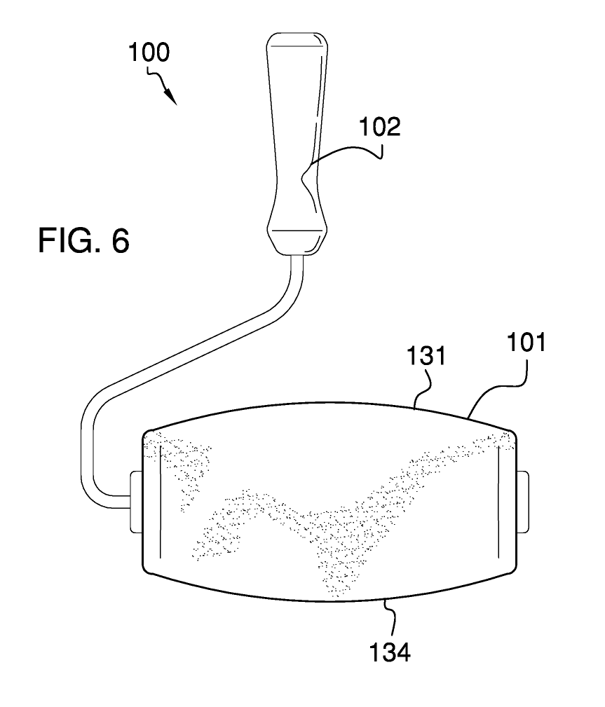

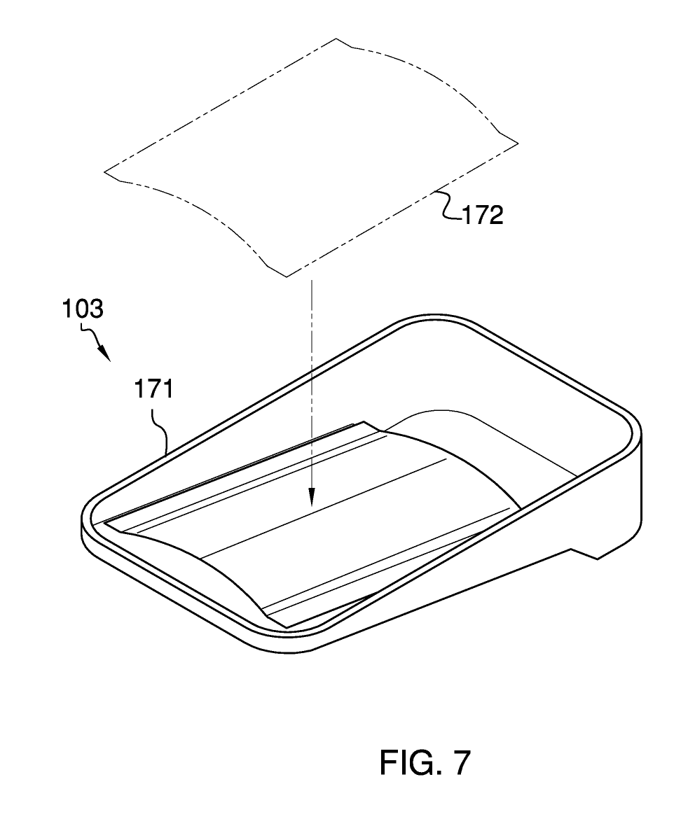

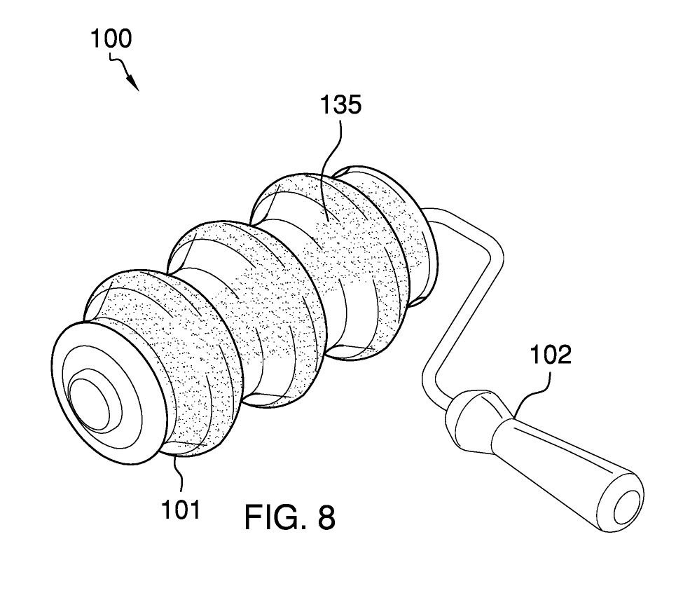

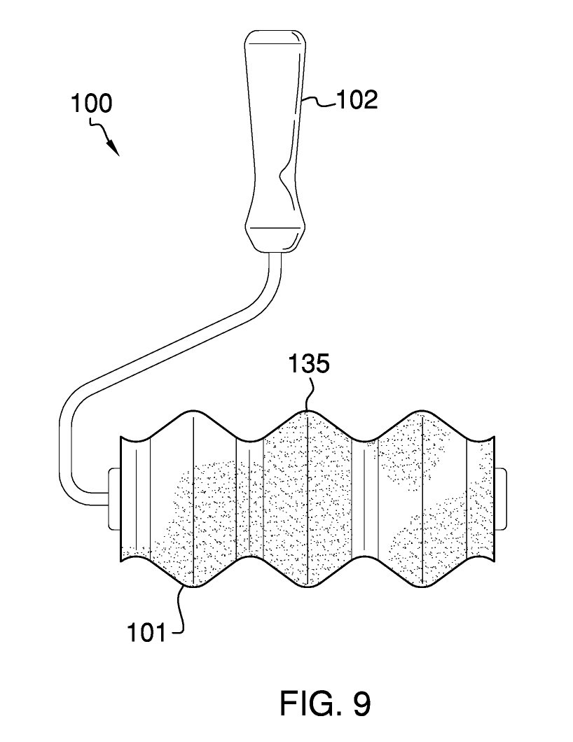

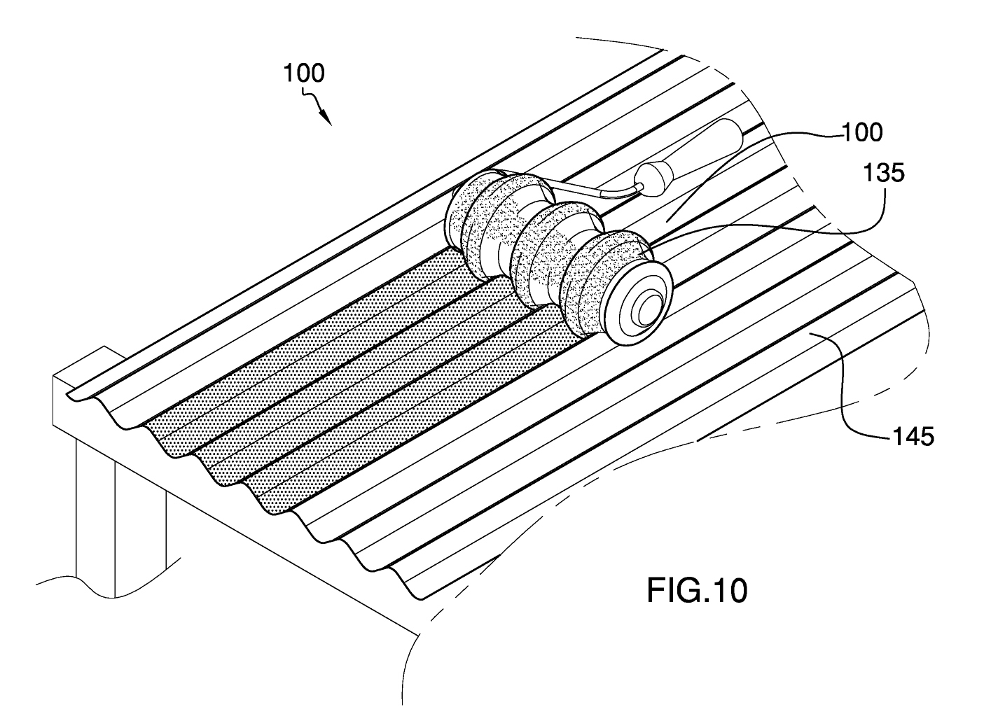

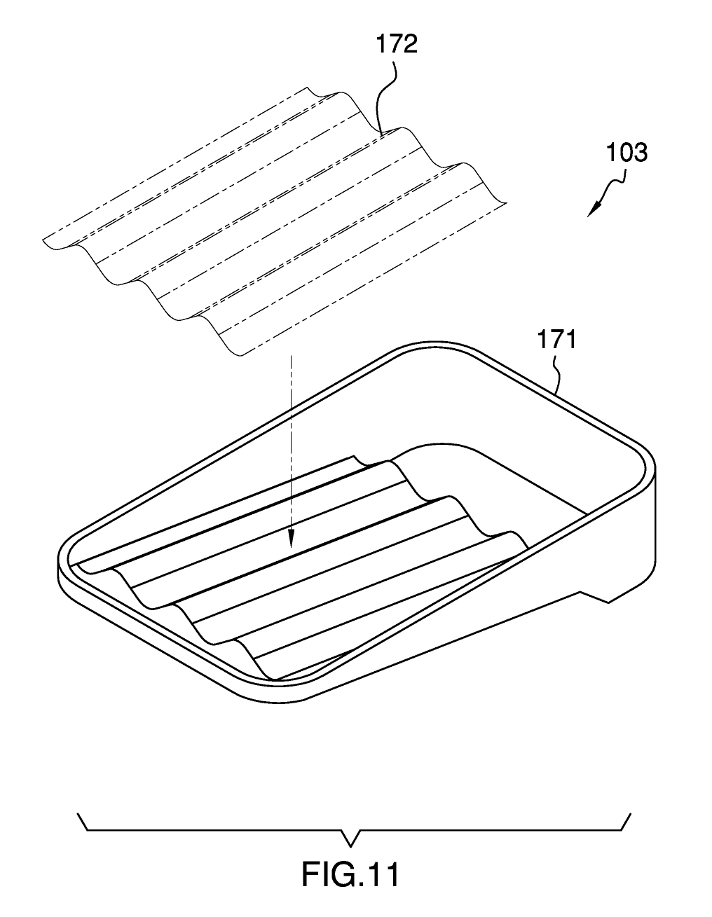

Detailed reference will now be made to one or more potential embodiments of the disclosure, which are illustrated in FIGS. 1 through 11.

The improved paint roller 100 (hereinafter invention) is configured for use in applying paint 152. The invention 100 is configured for use in applying paint 152 to a non-Euclidean application surface 141 wherein the non-Euclidean application surface 141 is selected from the group consisting of a concave surface 143, a convex surface 144, and a corrugated surface 145. The invention 100 comprises a roller sleeve 101, a handle 102, and a paint loading apparatus 103. The roller sleeve 101 is attached to the handle 102. The roller sleeve 101 presents a rolling non-Euclidean face 131 selected from the group consisting of a concave face 133, a convex face 134, and a corrugated face 135. The roller sleeve 101 is configured for use in applying the paint 152 to the non-Euclidean application surface 141. Specifically: 1) a roller sleeve 101 presenting a concave face 133 is intended to apply paint 152 upon a convex surface 144 of the non-Euclidean application surface 141; while, 2) the roller sleeve 101 presenting a convex face 134 is intended to apply paint 152 upon a concave surface 143 of the non-Euclidean application surface 141; and while, 3) the roller sleeve 101 presenting a corrugated face 135 is intended to apply paint 152 upon a corrugated surface 145 of the non-Euclidean application surface 141.

The invention 100 is used as a traditional paint 152 roller. The non-Euclidian application surface 141 refers to a non-planar surface that will be painted by the invention 100. The non-Euclidian application surface 141 is selected from the group consisting of the concave surface 143, the convex surface 144, and the corrugated surface 145.

The handle 102 is a readily and commercially available handle that is commonly used for with the traditional roller sleeve 101 of a paint 152 roller. The handle 102 comprises a spring cage 121, a spring frame 122, and a grip 123. The grip 123 comprises an interior screw thread 124.

The spring cage 121 is a commercially available spring cage 121 that is commonly used with the handle 102 of a paint 152 roller. The spring cage 121 further comprises a bearing that allows the spring cage 121 to rotate relative to the spring frame 122. The rotation of the spring cage 121 in turn rotates the roller sleeve 101 relative to the spring frame 122.

The spring frame 122 is commercially available U shaped structure that is commonly used to attach the spring cage 121 to the handle 102. The grip 123 is a cylindrical structure that is grasped by the user of the invention 100. The interior screw thread 124 is formed in the handle 102. The interior screw thread 124 is sized to receive the standard size of the exterior screw thread used on broom handles.

The roller sleeve 101 of the invention 100 is modified relative to the traditional roller sleeve 101 of a traditional paint 152 roller such that the roller sleeve 101 forms a curved surface referred to as a non-Euclidean face 131. The roller sleeve 101 is configured such that the roller sleeve 101 can be rolled along non-Euclidian application surface 141 such that the entire length 151 of the roller sleeve 101 is in contact with the non-Euclidian application surface 141 when paint 152 is applied to the non-Euclidian application surface 141. The roller sleeve 101 attaches to the handle 102 such that the roller sleeve 101 rotates freely. The roller sleeve 101 comprises a non-Euclidean core 111 and a napped covering 112.

The non-Euclidean core 111 is curved three-dimensional structure that is reminiscent of a cylinder. The non-Euclidean core 111 is formed as a quadric surface that is further defined with a center axis 161. The center of rotation of the non-Euclidean core 111 is aligned with the center axis 161. The curvature of the exterior surface of the non-Euclidean core 111 is formed such that the curvature of the exterior surface of the non-Euclidean core 111 aligns with the curvature of the non-Euclidian application surface 141 upon which the invention 100 is to apply paint 152. The non-Euclidean core 111 essentially replaces the function of the cylindrical core of a traditional paint 152 roller. The non-Euclidean core 111 comprises a non-Euclidean face 131 and an inner cylinder 132. The non-Euclidean face 131 is selected from the group consisting of the concave face 133, the convex face 134, and the corrugated face 135.

The napped covering 112 is an absorbent material that is used to draw paint 152 onto the roller sleeve 101. The napped covering 112 is a nap textile that is used to cover the exterior surface of the non-Euclidean core 111. The napped covering 112 transfers the absorbed paint 152 onto the non-Euclidian application surface 141 in the same manner as the traditional napped covering 112 of a traditional paint 152 roller. In the first potential embodiment of the disclosure, the napped covering 112 is formed as a tubular textile that slides over the exterior surface of the non-Euclidean core 111. The napped covering 112 is formed as an elastic textile such that the napped covering 112 will more closely fit the non-Euclidean face 131 of the non-Euclidean core 111.

The non-Euclidean face 131 is the exterior surface of the non-Euclidean core 111. The inner cylinder 132 is a negative space that is formed within the non-Euclidean core 111. The center axis of the inner cylinder 132 is aligned with the center axis 161 of the non-Euclidean core 111. The inner cylinder 132 is sized to receive the spring cage 121 such that the spring cage 121 is deformed as it is inserted into the inner cylinder 132.

The concave face 133 is a surface that has a concave appearance when viewed from the exterior of the non-Euclidean core 111. In the first potential embodiment of the disclosure, the shape of the curvature of the concave face 133 is formed as a hyperboloid of one sheet. The hyperboloid of one sheet is discussed in greater detail elsewhere in this disclosure. The concave face 133 of the non-Euclidean face 131 is configured for use with the convex surface 144 of the non-Euclidian application surface 141.

The convex face 134 is a surface that has a convex appearance when viewed from the exterior of the non-Euclidean core 111. In the first potential embodiment of the disclosure, the shape of the curvature of the convex face 134 is formed as an ellipsoid. The ellipsoid is discussed in greater detail elsewhere in this disclosure. The convex face 134 of the non-Euclidean face 131 is configured for use with the concave surface 143 of the non-Euclidian application surface 141.

The corrugated face 135 is a surface that has a corrugated appearance when viewed from the exterior of the non-Euclidean core 111. In the first potential embodiment of the disclosure, the shape of the curvature of the corrugated face 135 is geometrically similar to the corrugated surface 144 of corrugated metal structures built from corrugated metal. The corrugated face 135 and the corrugated surface 145 correspond and align such that the corrugated face 135 of the non-Euclidean face 131 can be placed flush against the non-Euclidian application surface 141 when the non-Euclidean surface is a corrugated surface 145.

The paint loading apparatus 103 comprises a paint tray 171 and a mimicking insert 172. The paint tray 171 is a commercially available paint tray 171 that is commonly used to load paint on a traditional paint roller. The mimicking insert 172 is a three dimensional structure that is geometrically similar to the non-Euclidean application surface 141 which is being painted. The paint loading apparatus 103 is placed in the paint tray 171 and is then covered in paint 152. The non-Euclidean face 131 corresponding to the mimicking insert 172 aligns with the mimicking insert 172 such that the non-Euclidean face 131 can be placed flush against the mimicking insert 172. The use of the mimicking insert 172 ensures that the paint 152 is evenly loaded on the roller sleeve 101 during use of the invention 100.

Once it is confirmed that the selected non-Euclidean face 131 and mimicking insert 172 both match the selected non-Euclidian application surface 141 the invention 100 can be used as a normal paint 152 roller.

The following definitions were used in this disclosure:

Absorbent: As used in this disclosure, absorbent is an adjective that refers to a material that is able to soak up a liquid such as water.

Align: As used in this disclosure, align refers to an arrangement of objects that are: 1) arranged in a straight plane or line; 2) arranged to give a directional sense of a plurality of parallel planes or lines; or, 3) a first line or curve is congruent to and overlaid on a second line or curve.

Cage: As used in this disclosure, a cage is an openwork structure that defines an interior volume within which an object may be contained.

Center: As used in this disclosure, a center is a point that is: 1) the point within a circle that is equidistant from all the points of the circumference; 2) the point within a regular polygon that is equidistant from all the vertices of the regular polygon; 3) the point on a line that is equidistant from the ends of the line; 4) the point, pivot, or axis around which something revolves; or, 5) the centroid or first moment of an area or structure. In cases where the appropriate definition or definitions are not obvious, the fifth option should be used in interpreting the specification.

Center Axis: As used in this disclosure, the center axis is the axis of a cylinder. The center axis of a pyramid refers to a line formed through the apex of the pyramid that is perpendicular to the base of the pyramid. When the center axes of two cylinder or cylinder like structures share the same line they are said to be aligned. When the center axes of two cylinder like structures do not share the same line they are said to be offset.

Center of Rotation: As used in this disclosure, the center of rotation is the point of a rotating plane that does not move with the rotation of the plane. A line within a rotating three dimensional object that does not move with the rotation of the object is also referred to as an axis of rotation.

Concave: As used in this disclosure, concave is used to describe: 1) a surface that resembles the interior surface of a sphere; or, 2) a function with a curvature structure wherein a chord that connects any two points of the function will be lesser than (graphically below) or equal to the value of the function at any point along the chord.

Convex: As used in this disclosure, convex is used to describe: 1) a surface that resembles the outer surface of a sphere; or, 2) a function with a curvature structure wherein a chord that connects any two points of the function will be greater than (graphically above) or equal to the value of the function at any point along the chord.

Correspond: As used in this disclosure, the term correspond is used as a comparison between two or more objects wherein one or more properties shared by the two or more objects match, agree, or align within acceptable manufacturing tolerances.

Corrugated: As used in this disclosure, the term corrugated describes a structure that is formed with a series of parallel and alternating ridges and grooves

Cylinder: As used in this disclosure, a cylinder is a geometric structure defined by two identical flat and parallel ends, also commonly referred to as bases, which are circular in shape and connected with a single curved surface, referred to in this disclosure as the face. The cross section of the cylinder remains the same from one end to another. The axis of the cylinder is formed by the straight line that connects the center of each of the two identical flat and parallel ends of the cylinder. Unless otherwise stated within this disclosure, the term cylinder specifically means a right cylinder which is defined as a cylinder wherein the curved surface perpendicularly intersects with the two identical flat and parallel ends.

Elastic: As used in this disclosure, an elastic is a material or object that deforms when a force is applied to it and that is able to return to its relaxed shape after the force is removed. A material that exhibits these qualities is also referred to as an elastomeric material.

Elastic Textile: As used in this disclosure, an elastic textile is a textile that contains elastic yarns as some of the yarns that make up the textile. An elastic textile is constructed such that the elastic textile will stretch when a force is applied and will return to its original shape when after the force is removed.

Elastic Yarn: As used in this disclosure, an elastic yarn is a yarn formed from elastomeric materials.

Ellipsoid: As used in this disclosure, an ellipsoid is a three dimensional geometric surface through which all planar surfaces are from either circles or ellipses. An ellipsoid is a type of quadric surface. The equation for an ellipsoid is: (x̂2/a)+(ŷ2/b)+(ẑ2/c)=d wherein a, b, c, and d are constants.

Exterior: As used in this disclosure, the exterior is use as a relational term that implies that an object is not contained within the boundary of a structure or a space.

Exterior Screw Thread: An exterior screw thread is a ridge wrapped around the outer surface of a tube in the form of a helical structure that is used to convert rotational movement into linear movement.

Geometrically Similar: As used in this disclosure, geometrically similar is a term that compares a first object to a second object wherein: 1) the sides of the first object have a one to one correspondence to the sides of the second object; 2) wherein the ratio of the length of each pair of corresponding sides are equal; 3) the angles formed by the first object have a one to one correspondence to the angles of the second object; and, 4) wherein the corresponding angles are equal. The term geometrically identical refers to a situation where the ratio of the length of each pair of corresponding sides equals 1.

Grip: As used in this disclosure, a grip is an accommodation formed within an object that allows the object to be grasped or manipulated by a hand.

Hyperboloid of One Sheet: As used in this disclosure, a hyperboloid of one sheet is a three dimensional quadric surface. A feature of the hyperboloid of one sheet is that a cross-section taken of the hyperboloid that is perpendicular to the center axis of the hyperboloid of one sheet is a shape selected from the group consisting of a circle or an ellipse. The equation for an ellipsoid is: (x̂2/a)+(ŷ2/b)−(ẑ2/c)=d wherein a, b, c, and d are constants.

Interior: As used in this disclosure, the interior is use as a relational term that implies that an object is contained within the boundary of a structure or a space.

Interior Screw Thread: An interior screw thread is a groove that is formed around the inner surface of a tube in the form of a helical structure that is used to convert rotational movement into linear movement.

Nap: As used in this disclosure, a nap refers to one or more loose yarns that are incorporated in a textile such that the separated, or “raised,” from the plane of the primary surface of a textile. A nap may: 1) take the form of a loop; or 2) take the form of loose “ends” extending beyond the textile. Within this disclosure, the terms pile and nap may considered synonyms.

Negative Space: As used in this disclosure, negative space is a method of defining an object through the use of open or empty space as the definition of the object itself, or, through the use of open or empty space to describe the boundaries of an object.

One to One: When used in this disclosure, a one to one relationship means that a first element selected from a first set is in some manner connected to only one element of a second set. A one to one correspondence means that the one to one relationship exists both from the first set the second set and from the second set to the first set. A one to one fashion means that the one to one relationship exists in only one direction.

Paint: As used in this disclosure, when used as a noun the term paint refers to a pigment based colloid or solution that is applied to a surface as a coating of the surface. When used as a verb, the term paint refers to the application of paint to a surface.

Paint Roller: As used in this disclosure, a paint roller is a rolling structure that: 1) is covered in an absorbent material; and, 2) is used to apply paint to a surface.

Quadric Surface: As used in this disclosure, a quadric surface is a three dimensional surface that varies in the three Cartesian coordinates in an algebraically defined manner that is related to conic sections. Euclidian planes as well as the surfaces of ellipsoids, spheres, paraboloids, and cones are examples of quadric surfaces. The Euclidian plane is technically considered a degenerate form of a quadric surface and, unless specifically stated otherwise within this disclosure, is explicitly included in this definition. Quadric surfaces are described by the general algebraic form: Ax²+By²+Cz²+Dxy+Exz+Fyz+Gx+Hy+Iz+J=0.

Relaxed Shape: As used in this disclosure, a structure is considered to be in its relaxed state when no shear, strain, or torsional forces are being applied to the structure.

Spring: As used in this disclosure, a spring is a device that is used to store mechanical energy. This mechanical energy will often be stored by: 1) deforming an elastomeric material that is used to make the device; 2) the application of a torque to a rigid structure; or 3) a combination of the previous two items.

Textile: As used in this disclosure, a textile is a material that is woven, knitted, braided or felted. Synonyms in common usage for this definition include fabric and cloth.

Tradition: As used in this disclosure, a tradition refers to: 1) a set of thoughts or expectations regarding a subject or object; or, 2) a method of using an object; that, 3) is perceived to be widely or commonly shared across a population of people; and that, 4) is perceived to be widely or commonly shared across at least two generations within the population of people.

Tubular Textile: As used in this disclosure, a tubular textile is a textile that is woven, knitted, or braided into a seamless tube like shape.

Yarn: As used in this disclosure, a yarn is continuous strand of textile fibers and filaments. Yarns are generally used in the production of fabrics. For the purposes of this disclosure, this definition explicitly includes yarns formed from a single filament such as a monofilament yarn.

With respect to the above description, it is to be realized that the optimum dimensional relationship for the various components of the invention described above and in FIGS. 1 through 11 include variations in size, materials, shape, form, function, and manner of operation, assembly and use, are deemed readily apparent and obvious to one skilled in the art, and all equivalent relationships to those illustrated in the drawings and described in the specification are intended to be encompassed by the invention.

It shall be noted that those skilled in the art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

What is claimed is:

1. A hand tool:
wherein the hand tool is configured for use in applying paint to a non-Euclidean application surface;
wherein the non-Euclidian application surface refers to a non-planar surface that will be painted by the hand tool;
wherein the non-Euclidean application surface is selected from the group consisting of a concave surface, a convex surface, and a corrugated surface;
wherein the hand tool comprises a roller sleeve, a handle, and a paint loading apparatus;
wherein the paint loading apparatus loads paint on to the roller sleeve;
wherein the roller sleeve is attached to the handle;
wherein the paint loading apparatus loads paint on to the roller sleeve;
wherein the roller sleeve presents a rolling non-Euclidean face;
wherein the roller sleeve is configured for use in applying the paint to the non-Euclidean application surface.

2. The hand tool according to claim 1
wherein the handle comprises a spring cage, a spring frame, and a grip;
wherein the spring cage further comprises a bearing that allows the spring cage to rotate relative to the spring frame;
wherein the spring frame is a structure that attaches the spring cage to the handle;
wherein the grip is a cylindrical structure.

3. The hand tool according to claim 2 wherein the rotation of the spring cage in turn rotates the roller sleeve relative to the spring frame.

4. The hand tool according to claim 3 wherein the roller sleeve is configured such that the roller sleeve can be rolled along the non-Euclidian application surface such that the entire length of the roller sleeve is in contact with the non-Euclidian application surface.

5. The hand tool according to claim 4
wherein the roller sleeve comprises a non-Euclidean core and a napped covering;
wherein the napped covering attaches to the exterior surface of the non-Euclidean core.

6. The hand tool according to claim 5
wherein the non-Euclidean core is curved three dimensional structure;
wherein the center of rotation of the non-Euclidean core is aligned with the center axis.

7. The hand tool according to claim 6
wherein the curvature of the exterior surface of the non-Euclidean core is formed such that the curvature of the exterior surface of the non-Euclidean core aligns with the curvature of the non-Euclidian application surface upon which the hand tool is to apply paint.

8. The hand tool according to claim 7
wherein the non-Euclidean core comprises a non-Euclidean face and an inner cylinder;
wherein the non-Euclidean face is the exterior surface of the non-Euclidean core;
wherein the inner cylinder is formed within the non-Euclidean core.

9. The hand tool according to claim 8 wherein the napped covering is an absorbent material that draws paint onto the roller sleeve.

10. The hand tool according to claim 9
wherein the napped covering is a nap textile;
wherein the napped covering transfers the absorbed paint onto the non-Euclidian application surface.

11. The hand tool according to claim 10
wherein the inner cylinder is a negative space;
wherein the center axis of the inner cylinder is aligned with the center axis of the non-Euclidean core.

12. The hand tool according to claim 11 wherein the inner cylinder is sized to receive the spring cage such that the spring cage is deformed as the spring cage is inserted into the inner cylinder.

13. The hand tool according to claim 12
wherein the non-Euclidean face is a concave face;
wherein the concave face applies paint upon the convex surface of a non-Euclidean application surface.

14. The hand tool according to claim 13 wherein the shape of the curvature of the concave face is formed as a hyperboloid of one sheet.

15. The hand tool according to claim 14
wherein the napped covering is formed as a tubular textile;
wherein the napped covering is formed as an elastic textile.

16. The hand tool according to claim 12
wherein the non-Euclidean face is a convex face.
wherein the convex face applies paint upon the concave surface of a non-Euclidean application surface.

17. The hand tool according to claim 16 wherein the shape of the curvature of the convex face is formed as an ellipsoid.

18. The hand tool according to claim 17
wherein the napped covering is formed as a tubular textile;
wherein the napped covering is formed as an elastic textile.

19. The hand tool according to claim 12
wherein the non-Euclidean face is a corrugated face.
wherein the corrugated face applies paint upon the corrugated surface of a non-Euclidean application surface.

20. The hand tool according to claim 19
wherein the napped covering is formed as a tubular textile;
wherein the napped covering is formed as an elastic textile.
